(19) United States
(12) Patent Application Publication
(10) Pub. No.: US 2009/0089440 A1
(43) Pub. Date: Apr. 2, 2009

(54) PROTOCOL FOR LEASING SOCKETS

(76) Inventor: JONATHAN CHESTER GATHMAN, Arnold, MO (US)

Correspondence Address: AT&T Legal Department - JW;Attn: Patent Docketing, Room 2A-207, One AT&T Way, Bedminster, NJ, 07921, US

(21) Appl. No.: 11/865,392

(22) Filed: Oct. 1, 2007

(51) Int. Cl. G06F 15/16

(52) U.S. Cl. 709/228

(57) ABSTRACT

A system for establishing a communication session in a networked deployment includes a negotiation between a client application and a service regarding the duration of the communication session. A client application sends a packet or datagram having a load and a request for a communication link. The request for a communication link includes a first proposed interval for a lease term between the client application and the service. The service may accept the first proposed interval and begin processing the load. Alternatively, the service may deny the request or counter-propose a second proposed interval for the communication link. Substantially concurrently with sending the second proposed interval, the service may begin processing the load.

### BACKGROUND OF THE DISCLOSURE

The present disclosure relates to networking protocols, and more specifically, to a protocol for establishing socket-level, lease-based, communication sessions between clients and servers.

### DESCRIPTION OF THE RELATED ART

Communication in computer networks is often implemented using Transmission Control Protocol (TCP) or User Datagram Protocol (UDP), which are part of the TCP/IP suite.

### BRIEF DESCRIPTION OF THE DRAWINGS

FIG. 1 depicts an environment in which a leased network connection is established in accordance with disclosed embodiments;

FIG. 2 is a diagrammatic representation of a packet or datagram having a protocol header in accordance with disclosed embodiments; and

FIG. 3 is a flow chart with blocks for communication between a client application and a service.

### DETAILED DESCRIPTION

In one aspect, a method for establishing a communication session between a client application and a service is disclosed. The method comprises a client application sending to a service a first request to establish a link. The first request includes a first proposed interval for the link. Some variations of the embodiment further include the service sending to the client application a second proposed interval for the link. The second proposed interval is less than the first proposed interval in some embodiments. The request may include a load which the service can use to conduct processing. The service may begin processing the request substantially contemporaneously with sending an acknowledge signal to the client application.

In another aspect, a system for negotiating a communication session at the transport layer between a client application and a service is disclosed. The system includes a client application enabled for sending a communication link request in a field of a protocol header. The field includes a proposed interval for the communication session. In some embodiments, the client application is further enabled for processing from a service a server acknowledgment including an acknowledgment header. The acknowledgment header includes an acknowledgment lease field for communicating a counter-proposed interval for the communication session.

As an additional aspect, a client application stored on machine readable medium is disclosed for sending to a service a first proposed interval for a communication session. The first proposed interval corresponds to a client-desired duration of a socket-level communication session. During the socket-level communication session, the service listens for packets from the client application, which may be determined by examining fields of protocol headers for incoming datagrams or packets. In other embodiments, the client application is further enabled for processing a counter-proposed interval from the service. The counter-proposed interval is less than the first proposed interval. The counter-proposed interval corresponds to a maximum duration for which the service is willing to listen for packets from the client application.

TCP/IP is a collection of protocols that support communications between networked computers or computer-like devices. TCP/IP and its related protocols define a means for how data can be processed, transmitted, and received on a TCP/IP network. Software components that perform the functions that enable a computer to participate in a TCP/IP network may be referred to as TCP/IP implementations. TCP/IP standards help ensure the compatibility of TCP/IP implementations.

The TCP/IP protocol system has layered components that each perform specific functions. The layered components may be referred to as a stack. In a four-layer TCP/IP model, the stack includes the application layer, the transport layer, the Internet layer, and the network access layer. Other descriptions or models of TCP/IP call for more or less than four layers. For example, the seven-layer Open Systems Interconnection model (OSI model) includes the application layer, the presentation layer, the session layer, the transport layer, the network layer, the data link layer, and the physical layer.

In the four-layer model, the network access layer provides an interface with a physical network by formatting data for the transmission medium and addressing data based on physical hardware addresses. The Internet layer provides logical addressing and routes data. The transport layer provides flow control, error control, and possibly acknowledgment services for communication within a network. The transport layer serves as an interface for network applications. For example, it provides an interface between a client application on a client machine and a service on the server machine. The application layer provides applications for troubleshooting, file transfer, remote control, and the like. It also supports network Application Programming Interfaces (APIs) to allow programs to access a network.

In the seven layer OSI model, the physical layer converts data into electric signals that pass through a transmission medium. The physical layer oversees the transmission of the data using the signals. The data link layer provides an interface with a network adapter and maintains logical links for a subnetwork, for example. The network layer provides logical addressing and routing. The transport layer provides error control and flow control for a network. The session layer establishes sessions between applications that communicate over a network. The presentation layer translates data into a standard format, manages encryption, and manages data compression. The application layer provides applications with a network interface, supports file transfer, and assists with communications between networked applications.

A client is a computer that requests or receives services from another computer on a network. A server is a computer that offer services to other computers on the network. A client application operates at the transport layer and communicates with a service operating on the transport layer of a server.

When communicating packets or datagrams between applications on different machines, each protocol layer on the receiving machine may need different information to process the incoming data. Accordingly, on the sending machine, as an outgoing transmission passes through the protocol stack, each layer may include a header along with actual data. The data may be repackaged at the next lower layer, and the next lower layer may include its own header. Typically, the reverse process occurs when the data is received on the destination computer. Specifically, as the data package moves up through the protocol stack, each layer unpacks the corresponding header and uses the data. Headers that are attached at the transport layer are referred to as protocol headers.

A package of data may have a different name depending upon where it is in the protocol stack. Data packages created in the application layer are often referred to as “messages.” Data packages created in the transport layer are called “segments.” If the data packages come from the transport layer's TCP protocol, they are often referred to as “datagrams.” A “segment” may be the product of the transport layer encapsulating a “message” from the application layer. Data packages at the Internet layer are also referred to as datagrams. The Internet layer typically encapsulates packages (e.g. datagrams or segments) from the transport layer. A data package at the network access layer is generally referred to as a “frame.” The network access layer encapsulates and may subdivide datagrams or segments. The network access layer turns frames into bitstreams.

As used in this disclosure, a client application operates at the transport layer and for example, functions to establish socket-level connections with one or more services at the transport layer on a server on the network. Embodiments disclosed herein relate to a protocol for establishing communication between clients and servers at the transport layer of the TCP/IP 4-layer model, for example.

Two common types of servers are print servers and file servers. A print server fulfills requests to print documents on a particular networked printer, for example. A file server may operate a disk drive or other data storage device and fulfill requests to read or write data to that device, for example. Requests to file servers or print servers travel across a network, up through protocol layers to the transport layer, where they are routed to the appropriate ports that identify the service that corresponds either to the file server or print server.

TCP is a connection-oriented protocol. TCP attempts to guarantee the delivery of data by providing error checking and flow control features not always used with UDP. UDP is a connectionless protocol and, as a result, generally has less overhead than TCP. Therefore, it is generally faster than TCP. In some cases, UDP depends on the application layer to accomplish error-checking.

In contrast to TCP, UDP is generally thought of as a “connectionless” or “stateless” way of communicating between a server application and a client application. Using UDP, client applications and server applications communicate using datagrams, which are short packets. Unlike TCP, UDP does not necessarily guarantee reliability or ordering of packets at the transport layer. Datagrams may arrive out of order or go missing without a system for detecting such problems. UDP is considered to have less overhead associated with it than TCP.

Every IP datagram or packet begins with an IP header. A header marks the beginning of the packet and may contain the source and destination address for the packet or datagrams. In some cases, packets or datagrams contain a trailer. The trailer, when included, marks the end of the packet and may contain a checksum used to determine if the packet suffered any corruption during transmission. Each header may contain multiple fields including, as examples, the IP addresses of the source and destination computers, the length of the datagram, and specific instructions to routers. A “time to live” (TTL) field may also be included in an IP datagram header which indicates the amount of time or the number of router hops that a datagram can survive before being discarded. In the event a TTL field is used to determine that a datagram should be discarded, a router may send a “Time exceeded” message using Internet Control Message Protocol (ICMP).

In accordance with disclosed embodiments, fields within protocol headers of packets or datagrams are used in negotiating a lease term at the transport layer of the OSI model. Disclosed embodiments relate to a connectionless or stateless protocol that operates at the socket level or transport level for establishing a link or communication session between a client application and a service on a server. The protocol used in disclosed embodiments herein may be referred to as Leased Connection Protocol (“LCP”). In some embodiments, a client application uses LCP to request a communication session with an LCP service hosted on a server. Similar to UDP, when a client application or LCP service communicates with LCP, there is no established connection such as with TCP. Instead, with LCP, a client application requests a lease from an LCP service. Typically, a proposed lease term is sent to the LCP service to inform the LCP service of the maximum amount of time the client application can wait for the LCP service to finish processing, for example. If the LCP service accepts the lease request, during the lease term, the LCP service will listen for packets from the client application. In some embodiments, the LCP service listens for packets from the client application by comparing the context ID of received packets to a predetermined ID associated with the negotiated lease or client application. Embodiments that utilize LCP may overlay a UDP datagram with LCP data, so that all existing routing, LAN, WAN, and Internet-enabled devices are able to route and handle LCP packets as normal. This prevents any otherwise necessary changes in existing IP based PC cards, TCP/IP stacks for operating systems, and so on. Therefore, embodiments use packet types that the Internet and its corresponding components are able to use without modification.

Upon receiving the lease request from the client application, if the service agrees to the lease term, the service may begin processing the request. The request may be included in the payload of a first packet or datagram sent by the client application to the service. Substantially contemporaneously with or after beginning to process the request, the service sends an acknowledge signal to the client application to inform it that the lease term has been accepted. If the lease term is set to expire and the client application needs more time, the client application may attempt to negotiate another lease with the service.

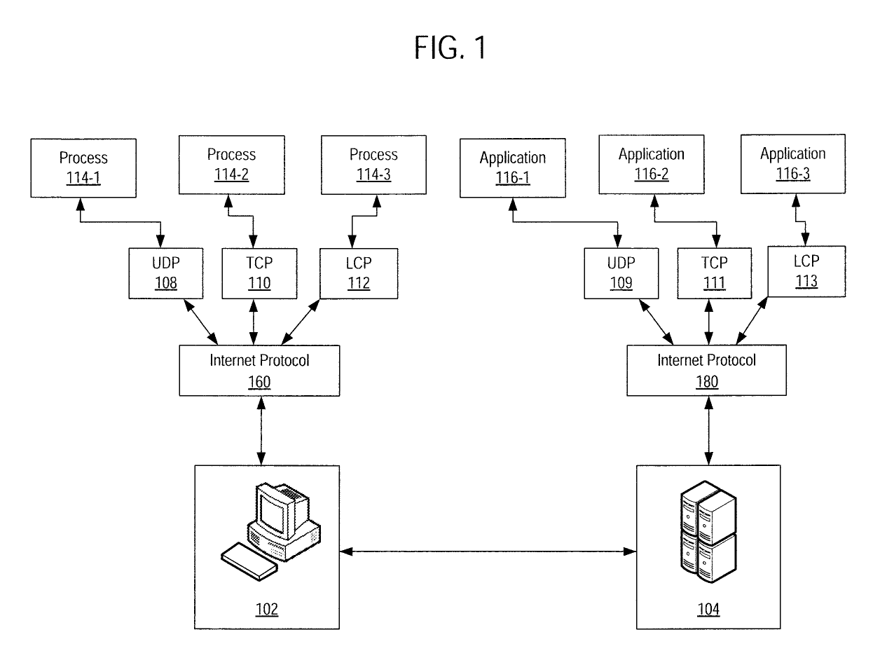

FIG. 1 depicts an example networked environment for communicating using disclosed embodiments. Client 102 runs several processes including 114-1, 114-2 and 114-3. As shown, client processes 114 communicate with server applications 116 which run on server 104. All three client processes 114 send data multiplexed for transmission using the IP physical connection 160. Similarly on the server side, data is received on a similar IP physical connection 180, demultiplexed, and passed to the appropriate server application 116. At the transport layer, TCP client application 110 may establish a TCP connection with TCP service 111. Also at the transport layer, UDP client application 108 may establish communication with UDP service 109. In accordance with disclosed embodiments, LCP client application 112 establishes communication sessions or links (for negotiated lease terms) with LCP service 113.

As shown, client process 114-1 communicates with server application 116-1 using UDP client application 108 and UDP service 109. Similarly, client process 114-2 communicates with server application 116-2 using TCP client application 110 and TCP service 111. In accordance with disclosed embodiments, client process 114-3 communicates with server application 116-3 using LCP client application 112 and LCP service 113.

As shown, LCP client application 112 sends a link request containing a proposed lease term to LCP service 113. In response, LCP service 113 either sends an ACK or DENY to LCP client application 112. In some embodiments, the link request is sent as part of a protocol header and the link request includes a payload with information that may be processed by the LCP service 113. If the LCP service 113 agrees to the link request term, the LCP service 113 begins processing the request. During the link or communication session, the LCP service 113 listens for datagrams or packets from the LCP client application 112 that are marked with a context ID as part of a protocol header. If packets are received with the proper context ID that is associated with a communication session or with a client application, LCP service 113 may send the packets to a packeter. In some embodiments, LCP service 113 creates a packeter. The “link” established between LCP client application 112 and LCP service 113 is ended upon expiration of the lease unless a new lease is successfully negotiated between the LCP service 113 and the LCP client application 112.

As shown in FIG. 1, a typical host computer such as client 102 or server 104 may have multiple software processes running concurrently. Each process may generate data that it sends using TCP, UDP, or in accordance with disclosed embodiments, using LCP. Accordingly, the IP layer (e.g. Internet protocol 180) of a server device (e.g., server 104) may receive datagrams or packets that originated in numerous processes (e.g. processes 114) on another machine (e.g. client 102). The many datagrams and packets may require de-multiplexing, so they end up at the correct process on the device that receives them. At the transport layer, the datagrams or packets each contain a protocol header and a load. The protocol header assists in setting up a communication link or session and routing the datagrams or packets. The load contains a portion of the data requested by a client process, for example.

Accordingly, multiple applications on a client machine and server machine may communicate simultaneously using either TCP, UDP, or LCP. Some applications employ port addressing at the transport layer to route packets or datagrams. In TCP/IP, the port may be referred to as a “transport layer address” and the process of routing using ports may be referred to as “transport-layer addressing” or “port-addressing.” Each port number within a particular IP device (i.e. client device or server device) identifies a particular software process within a device. Within UDP, TCP, or LCP datagrams or packets, a source port and a destination port may be included in a header. These are analogous to the fields for source address and destination address that may be used at the IP level, but the source port and destination port contain a higher level of detail. Specifically, the port addresses identify the originating process on the source machine and the destination process on the destination machine. The information may be filled in by TCP, UDP, or LCP middleware (software) before transmission and serve to direct the data to the correct process on the destination device.

Therefore, using port-addressing on the packaging end of a transfer, a server process may specify the source and destination port it wishes to use for the communication. These are encoded into a datagram header as either a TCP, UDP, or LCP header, as examples, depending on which transport layer protocol the application is using. When TCP, UDP, or LCP pass the data to IP (e.g., IP 160 in FIG. 1), the IP indicates the protocol type appropriate for decoding the datagram or packet. The source and destination port numbers may be encapsulated within a datagram's data area as part of the TCP, UDP, or LCP message.

In some embodiments, on the receiving end of a transfer, TCP/IP stack software of an operating system delivers a UDP datagram. The UDP datagram is then examined to determine whether it is an LCP packet. For example, a protocol field may be examined to determine which protocol is used (as examples, UDP or LCP). Then, in some embodiments, the contents of the datagram or packet may be passed to the appropriate client process based on the destination port number, for example. Therefore, port addressing may be used to route packets and datagrams in accordance with disclosed embodiments.

Addressing at the IP level and addressing as it is conducted by client applications is distinguishable. IP addressing occurs at layer three of the OSI model and addressing by client applications occurs at layer four of the OSI model, which is the transport layer.

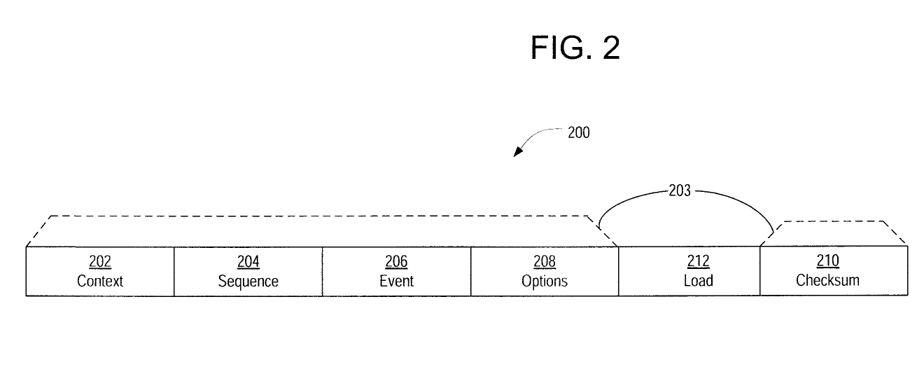

FIG. 2 depicts a datagram 200 having a protocol header 203. Protocol header 203 includes several component parts, for example context field 202. Context field 202 provides an identifier (ID) for a session or link between a client application and server application. If a series of datagrams arrives at a service (on a server), the service may use the context field 202 to associate the datagrams with a particular session, link, or client application. In this way, a service can use the context field 202 to “listen” for packets during a communication session. Alternatively, in some embodiments, context field 202 may include the source port and the destination port to be used during a session. Accordingly, if email messages are typically sent to a particular port and protocol header 203 was part of an email message, context field 202 may contain a number corresponding to the appropriate port for email messages. For some common applications such as email, a standard list of port numbers is published by the Internet Assigned Numbers Authority (IANA).

As shown, protocol header 203 optionally includes sequence field 204 for identifying the position in a sequence of datagrams associated with the underlying datagram for protocol header 203. In other words, sequence field 204 assists in determining the order of several related datagrams to help ensure the associated data is reassembled in the proper order by the service or server application.

As shown, protocol header 203 includes event field 206. In accordance with disclosed embodiments, a client application populates event field 206 with a first proposed interval for a link or communication session. In response, a service may provide a counter-proposed interval in the event field 206 in an ACK or DENY packet or datagram. Therefore, event field 206 is used for negotiating a lease term for a communication session.

As shown, protocol header 203 includes options field 208, which may be used to provide security credentials and other qualities of service when sending and receiving datagrams. For example, options field 208 may be populated with a unique identifier or an authentication credential that can be used by a receiving party to verify that the packet is from a trusted source. This helps provide security features to be implemented at the transport layer. Protocol header 203 includes checksum field 210, which can be used to verify the integrity of the packet associated with protocol header 203. For verifying the integrity of the packet, any of a number of data verification schemes may be used including Message-Digest algorithm 5 (MD5). For MD5 or another such cryptographic hash function, checksum field 210 may contain a message digest or a digital fingerprint, as examples. Alternatively, checksum field 210 may contain an indication of the number of packets or datagrams successfully sent to allow for verification by the receiving party with the number of packets received.

In some embodiments, protocol header 203 is dynamic in that its size may change. Accordingly, protocol header 203 may contain an optional offset field (not shown) that provides an indication of the size of the protocol header 203. In this way, protocol header 203 discloses the size of itself to allow a recipient to determine when the datagram's load begins.

In addition, protocol header 203 may contain an optional pointer field (not shown) to identify any significant or urgent data contained in the packet. Further, protocol header 203 may contain a second options field (not shown) that provides the maximum segment size for a packet, for example. Still further, an optional padding field (not shown) may be included within protocol header 203 to ensure that protocol header 203 finishes on a proper boundary, for example a 32 bit boundary.

The fields of protocol header 203 illustrated in FIG. 2 and discussed herein are provided for illustrative purposes only and are meant as instructive rather than limiting. Alternate embodiments may have more fields, less fields, or different fields than header 203.

As discussed above, protocol header 203 includes event field 206 that may be populated by a client application to communicate to a service a first proposed interval for a communication session. The communication session consists, for example, of the service listening for packets or datagrams from the client application. In an embodiment, if the service agrees with the first proposed interval, the server application may send an ACK (acknowledgment packet) to the client application with a second proposed interval in event field 206. The second proposed interval may equal the first proposed interval. Alternatively, some other form of acknowledgment may be provided by the service in event field 206.

Upon a service receiving datagram 200 which includes an acceptable first proposed interval in event field 206, the service may begin processing the client's request (i.e., load 212) substantially contemporaneously with sending the ACK. However, if the server application were unable to dedicate the time initially requested by the client application, the event field 206 in the ACK datagram, or otherwise in a DENY datagram, may contain a second time interval that is less than the first time interval. Alternatively, the service may populate event field 206 in the acknowledgment packet with some other indication that the server was unavailable for the first proposed time interval. In some embodiments, if the service sends a second time interval that the client application agrees to, the client application may send an acknowledgement packet with the event field 206 populated with the second proposed time interval. In this way, a client application and the service communicate and negotiate regarding the duration of a link or session and for obtaining access to a socket.

A software developer that designs a network application (for example a client application or a server application) may choose whether to use TCP, UDP, or LCP as a transport protocol. Network communication using the TCP protocol requires conforming to a complex system of announcements and acknowledgments that are basic to TCP's connection-oriented structure. At the beginning of a TCP connection, a three-way handshake may be performed, in part, to synchronize sequence/acknowledgment fields that may be later incremented to verify that data is properly received. Referring again to FIG. 1, TCP client application 110 sends a segment with a synchronize (SYN) flag set to 1 and an acknowledge (ACK) flag set to 0 to TCP service 111. The SYN flag announces TCP client application 110's attempt to open a socket level connection with TCP service 111. TCP service 111 receives TCP client application 110's segment and returns a segment with the SYN field set to 1 and the acknowledge field set to 1. In return, TCP client application 110 sends a segment to TCP service 111 that acknowledges receipt of TCP service 111's segment with the SYN field set to 0 and the ACK field set to 1. After the three-way handshake, a connection is opened, and TCP modules transmit and receive data using a sequence and acknowledgment scheme.

When it is time to close the connection between TCP client application 110 and TCP service 111, TCP client application 110, for example, places a segment in the queue of segments being sent with a finish (FIN) field set to 1. The server application 116-2 on server 104 then enters what is referred to as a FIN-WAIT state in which server application 116-2 continues to receive and process segments already queued, but no additional segments are accepted. When TCP service 111 receives the FIN segment, it returns an ACK to TCP client application 110, sends any remaining segments, and notifies client process 114-2 that a FIN was received. TCP client application 110 sends a FIN segment to TCP service 111, which TCP service 111 acknowledges, and the connection is closed.

Accordingly, TCP sends and receives data through connections that must be requested, opened, and closed according to the rules of TCP. TCP provides an interface through which applications can have access to a network. For example, TCP client application 110 provides access to client process 114-2 across a network to server 104. Interfaces are normally provided through TCP ports, and in order to provide a connection through a port, a TCP interface to the application must be “open.” TCP supports two open states including “passive open” and “active open.” Using the passive open state, an application or a process notifies TCP that it is prepared to receive incoming connections through a TCP port. During a passive open state, a pathway from TCP to an application is opened in anticipation of an incoming connection request. For example, server application 116-2 may notify TCP service 111 that it is prepared to receive incoming connections through a TCP port. Accordingly, a pathway from TCP service 111 to server application 116-2 is opened in anticipation of receiving an incoming connection request, for example from client process 114-2.

During a TCP connection, a server application does not know how long a connection to a client application will last. Also, since both sides have to agree to close, a connection may be left open on the server end after a client application has gone off-line or malfunctioned. For example, server application 116-2 does not know at the beginning of a connection how long a connection with client process 114-2 will last. If client process 114-2 contains bugs that cause it to misbehave or if client process 114-2 otherwise goes off-line, server application 116-2 may be left waiting, which would generally degrade performance.

Another TCP state is “active open.” To enter this state, an application requests that TCP initiate a connection with another computer that is in the passive open state. For example, server application 116-2 may request that TCP service 111 initiate a connection with TCP client application 110 and client process 114-2. If an application is not in an active open or a passive open state, it may be in a closed state.

Using LCP, a “lease concept” is applied at the transport layer during the establishment of a communication session between a client application and a service. For example, LCP client application 112 may instruct LCP service 113 that certain requested processing either needs to be performed within 30 seconds or else the processing is not needed. Thus, if LCP service 113 is unable to process the request within 30 seconds or LCP service 113 is otherwise unable to accommodate a session for the proposed lease term, LCP service 113 may send a DENY packet in response to the request.

Having a protocol that requires client applications to propose a lease term to establish a communication session at the transport layer contributes to the efficiency and performance, particularly for applications running on server 104. It is problematic when a client application requests processing from a service, the service begins processing the request, and then the client application, perhaps from being impatient, goes away because it has not received the information in time. In previous systems, if the client application made a request and only had 30 seconds to wait, and the service took 40 seconds to process the request, processing done by the server application was wasted once the client application went away after 30 seconds. However, using LCP, the client application can inform a service of the amount of time it is willing to wait for the service to process the request. This scheme lessens the likelihood that the service will ultimately waste its efforts, for example by processing something for 40 seconds only to have the client application go away.

Some client applications making requests to services will set an internal TIMEOUT value, to protect the client application from hanging if there are network issues, for example. In some embodiments, the TIMEOUT value corresponds to the proposed lease term, so that the TIMEOUT value is transmitted to a service. The service is then able to determine how long a client application is willing to wait and this allows the service to perform a check on whether it has enough time or resources to work on the client application request. If the client application is denied by the service sending a DENY in the protocol header field, the client application may then seek services from another service. If the service and the client application negotiate a communication session, and the service unexpectedly takes longer than the lease term for processing, and the client application has not requested additional lease time, then the service may abandon processing midstream because the service could safely assume that any further processing would be wasted. If a client application goes away or misbehaves, the service will only be committed to processing during the lease term and will not be indefinitely caught and held in an ambiguous state, as may result in some TCP protocol systems. Therefore, in the event of a faulty client application, processing can be abandoned within a reasonable timeframe, allowing the service to provide processing to more stable, better-written, or better behaved client applications. In some embodiments, a service may begin to identify faulty clients and, for those client applications with a history of failing to live up to negotiated leases, a service may limit its time spent on them. This may provide additional protection against intentional or unintentional denial of service attacks, which can be vital in long-running processes that require robust availability. In this way, LCP allows for quality of service (QOS) to become a part of a communication session even before a communication session is established. The LCP protocol is well-suited for asynchronous messaging in that it closely models a queue or a topic, while providing scalability and robustness of peer-to-peer models. LCP concepts may be modeled and integrated into network Application Programming Interfaces (APIs) (e.g. channels) or incorporated into frameworks.

Using LCP, when a service receives a request from a client application, if the service agrees to the lease term, the service may begin processing the request substantially contemporaneously with sending the client application an ACK as part of a protocol header. In some embodiments, the ACK may contain the proposed lease term mirrored back to the client application to indicate that the service agrees with the lease term. In other embodiments, the ACK may contain bits that indicate an accept or bits that indicate a deny. In other embodiments, the ACK may contain a counter proposal for a lease term. Upon receiving the counterproposal, the client application may wish to acknowledge acceptance of the counterproposal by, for example, sending the counter-proposed lease term to the service. In this way, the client of this application and the service negotiate a lease for a communication session. Having such leased communication sessions lessens the likelihood that a service may process a request to result in data that is ultimately thrown away due to an impatient client moving on, for example.

In some embodiments, the LCP protocol header used in negotiating a lease term for communication session may contain security features. In other words, LCP provides for protocol level security features, which is distinguishable from TCP and UDP protocols, as examples. For example, protocol header 203 may contain in the options field 208 data used by a service to determine whether a requesting client application is from a valid, accepted, or approved client.

As shown in FIG. 1, several network applications may be running on the same computer, such as client 102. Protocol implementation must provide some means for determining which incoming packet belongs with each application. In some cases, TCP/IP establishes an interface from the network to the applications through a system of logical channels sometimes referred to as ports. Ports transfer data between the applications and protocol software. The port may be defined as an internal address that provides an interface between an application and the transport layer of TCP/IP.

The transport layer serves as an interface between network applications and the network and allows for delivering network data to particular applications. Using either TCP, UDP, or LCP, applications can address data using port numbers. A port is an address that serves as a pathway from an application to the transport layer or from the transport layer to the application. For example, a port would serve as a pathway from client process 114-3 to LCP client application 112. In TCP and UDP, some port numbers for particular services are well-known and widely accepted. For example, in TCP, compression utility is handled in TCP port 3 and network status is handled with TCP port 15. Similarly, well-known UDP ports include port 7 for echo, port 15 for network status, and port 9 for discard. A port address targets data to a particular application. A socket is an address that may be formed by combining a port number with an IP address for a computer. A socket addressing system enables protocols such as TCP, UDP, and LCP to multiplex and de-multiplex data received at lower levels of the TCP/IP stack both to destination applications and from originating applications. Because a socket address combines an IP number with a port number, it enables an application on a machine to have a unique identifier, or at a minimum, an identifier that is unique enough to accomplish data routing within a network. A socket API may receive data through the socket and pass the data to the appropriate application. A domain name service (DNS) may run on the application layer and provide name resolution services for computers on a TCP/IP network. In addition, a directory service (DS) may run and provide information regarding the locations of available network resources.

According to disclosed embodiments, a server process that accepts a proposed lease term “listens” to the requesting client process during the lease term. Specifically, the server process accepts datagrams with a particular context ID and may add the accepted datagrams to a packager for sending to a server application, for example.

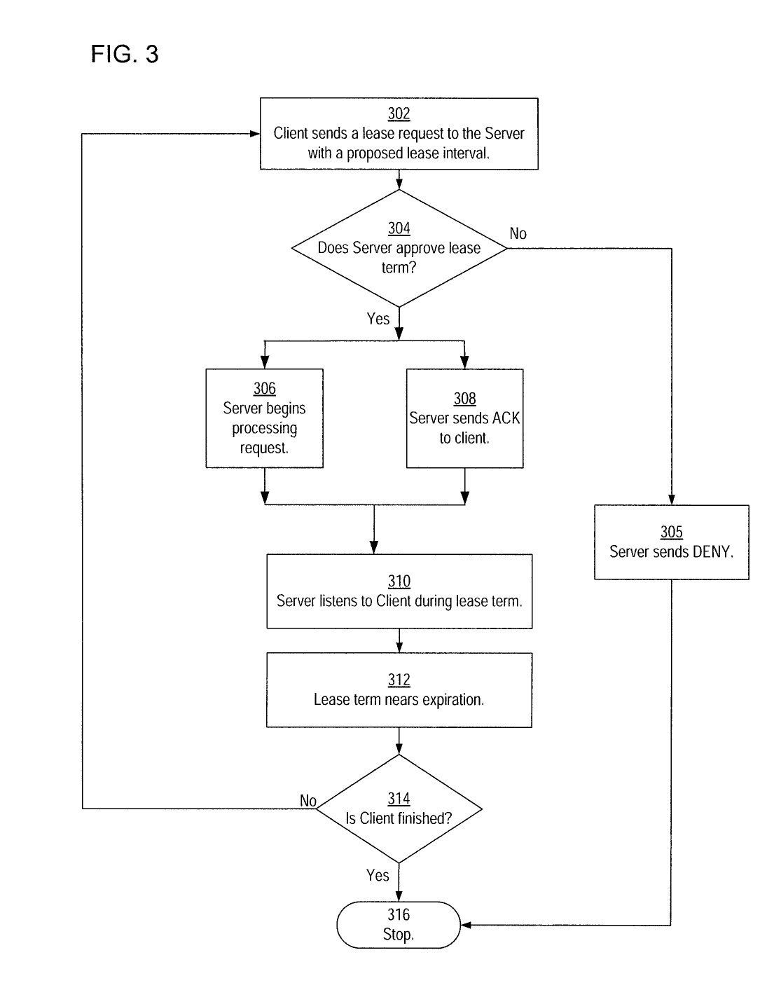

FIG. 3 illustrates, in block diagram form, aspects of a client application (i.e. Client) and an LCP service (i.e. Server) negotiating the expected duration of a communication session in accordance with disclosed embodiments. Block 302 includes a client application sending a lease request to an LCP service on the server. The lease request may be part of a first packet created with the LCP protocol. The lease request includes a protocol header with a field having the proposed lease term which represents, for example, the minimum amount of processing time that the client application requires. In addition to the proposed lease term, the first packet may include data that requests service from the LCP service or a related server application. Alternatively, the first packet may include the first part of a message stream. Block 304 provides for the LCP service determining whether it approves the proposed lease term sent by the client application. The LCP service may determine, after checking its resources, that it does not have the time or resources to service the client according to the client application's request. Alternatively, the LCP service may access a database to determine whether a particular client application is known to be a bad actor, which would be another ground for denying a lease request. In either case, if the LCP service does not have the resources or does not wish to service the client application, in block 305 the LCP service sends a DENY as part of a protocol header to the client application.

If the LCP service approves the lease term proposed in block 302, then the LCP service sends the client application an ACK in block 308 and begins processing the request in block 306. As shown, blocks 308 and block 306 may be performed substantially contemporaneously, so that processing by server applications or the LCP service does not have to wait on another acknowledgment sent by the client application, for example. In some embodiments, the ACK sent by the LCP service contains the proposed lease term mirrored back to the client application to tell the client application that the lease term has been accepted. In some embodiments, the LCP service may counter-propose a shorter lease term by including it in an ACK packet or, alternatively a DENY packet. If the LCP service denies the link request from the client application, the client application may go to another service. Alternatively, the client application may shorten the time that it requests from the LCP service. In this way, the LCP service may have the ability essentially to “train” client applications that tend to monopolize the resources of the LCP service.

Upon the lease term being accepted by the LCP service, block 310 provides for the LCP service listening for relevant packets from the client application during the lease term. The LCP service listens for relevant packets by checking the protocol headers of arriving datagrams to determine whether the context ID associated with the communication session is included in the protocol headers. In some embodiments, the LCP service may create a packeter that accepts packets, puts them in order, and tracks all that have been acknowledged.

As the lease term nears expiration, in block 312 a client application may prepare to ask for more time. Block 314 involves the client application determining whether it is finished with required processing. If it is not finished, block 302 is repeated and the client application sends a lease request or a lease extension request to the LCP service. On the other hand, if the client application is finished processing, then the communication session or link is stopped in block 316. As a courtesy, the client application may optionally send an “all done” message to the LCP service. Similarly, as a courtesy, the LCP service may optionally send a “session expired” message to the client application.

Therefore, disclosed embodiments permit a client application and server application to negotiate a duration for the server application listening for datagrams from the client application. In contrast to TCP connections, LCP communication sessions are connectionless. In some embodiments, a server application is enabled to monitor a ratio of proposed intervals that are accepted by server applications. If the ratio of proposed intervals that are accepted is too low, the client application may adapt to decrease future proposed intervals, thereby increasing the likelihood of acceptance.

Embodiments disclosed herein are intended to operate in an essentially stateless manner such as UDP. In cases in which the overhead associated with verification of packet delivery creates too much inefficiency, a stateless scheme may be preferable. Disclosed embodiments may be embodied in middleware. Middleware is computer software, stored on computer readable medium, enabled for connecting software components or applications. Middleware can be used to support complex and distributed applications including, web servers, application servers, content management systems, and similar tools, as examples. Some embodiments include middleware enabling a client application and a server application effectively to negotiate one or more periods for a communication session. In some embodiments, packet or datagram delivery may occur between a client application and a service using the IP addresses of the two data processing systems. Throughout the process of packet or datagram delivery, embodied protocols may interact with other network-level protocols that are enabled for data transport.

Embodiments disclosed as operating with LCP are intended to be compatible with TCP, and UDP protocols. Further, embodiments may be compatible with a multitude of other protocols for sending information, data, and files between networked computers. These protocols include FTP (File Transfer Protocol) that is ostensibly used for transferring files, SMTP (Simple Mail Transfer Protocol) that is used for sending e-mails, and SNMP (Simple Network Management Protocol) that is used for accomplishing network administration. An additional compatible protocol is ICMP (Internet Control Message Protocol), which is used by networked computers to send, for example, error messages that hardware or a connection may be unavailable. ICMP may be used for a ping tool, in which an echo request is sent by a client application and an echo response is sent by a server application to both determine whether the server is reachable and to determine how long packets take to travel to and from the server application. Embodiments using LCP may be a separate protocol than the above-referenced protocols, may be modified versions of these protocols, or may work in conjunction with these protocols.

The Open Systems Interconnection Basic Reference Model (“OSI model”) is a model for describing network protocol design. The OSI model was developed as part of Open Systems Interconnection (OSI) initiative. The OSI model may be referred to as the OSI seven layer model, which is made up of the application, presentation, session, transport, network, data link and physical layers. Although disclosed embodiments do not necessarily strictly fit with the OSI model, they can generally be characterized as existing on the transport layer. The transport layer controls the establishment of and reliability of a given link by managing flow control, segmentation-desegmentation, and error control. Some protocols are state and connection oriented. This means that the transport layer can keep track of the segments and retransmit those that fail. To save overhead and otherwise enhance performance, embodiments may be stateless, without the ability to verify reception of packets.

Embodiments using LCP are intended to be distinguishable in some ways from the TCP protocol. TCP is a connect-based protocol, commonly considered to have at least 11 states. These states include: (1) LISTEN; (2) SYN-SENT; (3) SYN-RECEIVED; (4) ESTABLISHED; (5) FIN-WAIT-1; (6) FIN-WAIT-2; (7) CLOSE-WAIT; (8) CLOSING; (9) LAST-ACK; (10) TIME-WAIT; (11) CLOSED. The LISTEN state represents waiting for a connection request from any remote TCP and port. The SYN-SENT represents waiting for the remote TCP to send back a TCP packet with the SYN and ACK flags set. The SYN-RECEIVED state represents waiting for the remote TCP to send back an acknowledgment after having sent back a connection acknowledgment to the remote TCP. The ESTABLISHED state represents that the port is ready to receive/send data from/to the remote TCP. The TIME-WAIT state represents waiting for enough time to pass to be sure the remote TCP received the acknowledgment of its connection termination request. In TCP protocol sessions, the connection termination phase may use a four-way handshake, with each side of the connection terminating independently. When an endpoint wishes to stop its half of the connection, it transmits a FIN packet, which the other end acknowledges with an ACK. Therefore, a typical teardown requires a pair of FIN and ACK segments from each TCP endpoint. In some cases, a connection can be “half-open”, in which case one side has terminated its end, but the other has not. The side that has terminated can no longer send any data into the connection, but the other side can. In other cases, a three-way handshake may be used in terminating a connection; in this case, when host A sends a FIN and host B replies with a FIN & ACK (combining the two steps) and host A replies with an ACK. Unlike TCP, client applications and services communicating with LCP do not establish connections per se. Also, in some embodiments, LCP protocol allows for communication between a client application and service without using TCP states 2-10 listed above. Using LCP, a lease term for a session is negotiated and a server application listens for packets from the client application for the lease term. Toward the end of a lease term, the client may attempt renegotiating another lease with the server application.

Embodiments use a leased concept on the low packet level portion of TCP/IP with the benefits that qualities of service issues can be dealt with early in the stack. This provides a framework for a more robust service that is not wasting resources waiting on misbehaving clients, and provides for faster throughput of messages by reducing the overhead. Thus, there is a more efficient and more responsible service which is more responsive to good clients by reducing the impact of bad clients.

Embodiments use an allowed time mechanism, supported by new elements of data overlaid on a UDP datagram for context ID and event rather than the multiple states of TCP/IP. This leads to reasonable and mutually agreed-upon session times, in which the client cannot simply grab a connection and leave it open forever as is a common problem with TCP.

The above disclosed subject matter is to be considered illustrative, and not restrictive, and the appended claims are intended to cover all such modifications, enhancements, and other embodiments which fall within the true spirit and scope of the present disclosure. The term “computer” is used herein for illustrative purposes and is not meant to limit the subject matter of the appended claims to, for example, a desktop computer. To the contrary, the term computer may also include, as examples, cell phones, wrist watches, home appliances, televisions, automobile components, and other devices that may participate in wired or wireless device networks. The scope of the claimed subject matter should be determined by the broadest permissible interpretation of the following claims and their equivalents, and shall not be restricted or limited by the foregoing detailed description.

What is claimed is:

1. A method of establishing a communication session between a client application and a service, the method comprising:
receiving by a service a communication session request sent from a client application, the communication session request including a first proposed interval for the communication session; and
sending from the service to the client application a server acknowledgment.

2. The method of claim 1, further including:
the service listening for datagrams from the client application during the communication session.

3. The method of claim 2, wherein the server acknowledgement includes a second proposed interval for the communication session.

4. The method of claim 3, wherein the second proposed interval is less than the first proposed interval.

5. The method of claim 2, wherein the communication session request is sent in a packet header, wherein the packet includes a load, the method further comprising:
beginning processing the load by the server substantially contemporaneously to or prior to sending the server acknowledgment.

6. The method of claim 2, further comprising:
matching the load to a context ID, wherein listening for datagrams from the client application includes comparing a plurality of protocol header fields from corresponding datagrams to the context ID.

7. The method of claim 4, further comprising:
receiving by the service from the client application an extension request to prolong the communication session.

8. The method of claim 6, further comprising:
collecting a plurality of datagrams if the plurality of protocol header fields match the context ID; and
placing in order the collected plurality of datagrams.

9. The method of claim 3, further comprising:
the client application sending the service a plurality of datagrams during a period, the period having a length equal to or less than the second proposed interval.

10. A system for negotiating a communication session at the transport layer, the system comprising:
a client application enabled for sending a communication link request to a service, wherein the communication link request includes a proposed interval for the communication session.

11. The system of claim 10, wherein the client application is further enabled for:
processing from the service an acknowledgment included in a protocol header, wherein the protocol header has a field including a counter-proposed interval for the communication session.

12. The system of claim 11, wherein the counter-proposed interval is less than the proposed interval.

13. The system of claim 10, wherein the client application is further enabled for:
sending a client lease extension request including a proposed lease extension interval.

14. The system of claim 13, wherein the client application is further enabled for:
processing a service lease extension acknowledgment including a counter-proposed extension interval that is less than the proposed lease extension interval.

15. The system of claim 11, wherein a server begins processing a client application request substantially contemporaneously with sending the server acknowledgement.

16. The system of claim 11, wherein transportation of a plurality of packets occurs by the client application sending to the service a plurality of packets without the service verifying the correct order of the plurality of packets.

17. The system of claim 16 wherein the client application multicasts the plurality of packets to a plurality of services.

18. The system of claim 14, wherein the service verifies an order of the plurality of packets.

19. A client application stored on machine readable medium, the client application enabled for:
sending to a service a first proposed interval, the first proposed interval corresponding to a client-desired duration of a socket-level communication session, wherein during the socket-level communication session the service analyzes incoming packets for protocol headers including a context ID associated with the client application.

20. The client application of claim 19, wherein the client application is further enabled for:
processing a counter-proposed interval from the service, wherein the counter-proposed interval is less than the first proposed interval, wherein the counter-proposed interval corresponds to a maximum duration for which the service is willing to listen for packets from the client application during the socket-level communication session.
